(19) United States
(12) Patent Application Publication
(10) Pub. No.: US 2023/0286734 A1
(43) Pub. Date: Sep. 14, 2023

(54) COUPLING SYSTEM FOR A CONTAINER

(71) Applicants: MZIGO S.A., Luxembourg (LU); CONTAINER QUICK LOCK, Schoten (BE)

(72) Inventor: Leendert Johannes Marinus BENSCHOP, ND Jaarsveld (NL)

(21) Appl. No.: 18/017,185

(22) PCT Filed: Jul. 22, 2021
(86) PCT No.: PCT/EP2021/070489

§ 371 Date: Jan. 20, 2023

(30) Foreign Application Priority Data
Jul. 22, 2020 (LU) LU101944

(51) Int. Cl. B65D 90/00

(52) U.S. Cl. CPC B65D 90/0006

(57) ABSTRACT

A coupling device for a container comprises a housing (12) with a front opening (22); a hollow shaft (20) having a cylindrical passage (21) therein, axially displaceable therein and moveable outwardly to engage a cooperating mating receptacle (24). Detent elements (26) are provided in shaft (20) and are able to come into locking engagement with the mating receptacle (24). A control pin (30) is configured for interacting with the detent elements (26). Actuating means configured to selectively control movement of the shaft (20) to move it from the rest position to the active position, and of the control pin (30), to move the detents elements from the retracted position to the retaining position. Also presented is a beam for a container frame structure, wherein the coupling device (10) is mounted at one end of a beam and the mating receptacle (24) is mounted at the other end of the beam.

### TECHNICAL FIELD

The present disclosure generally relates to a coupling system for joining adjacent containers together.

### BACKGROUND

Containers, such as freight or shipping containers, are rectangular box-like structures that usually have so-called heavy-duty corner fittings arranged at each of the eight corners of the structure. To allow adjacent containers to be coupled together (horizontally and/or vertically), the corner fittings are provided with elongated apertures, which can receive clamping heads of fixing devices.

The corner fittings are generally rectangular in cross-section and are welded to the frame of the containers. They usually have one large aperture in a top or bottom face of the fitting, and two smaller apertures on two adjacent sides of the fitting.

Adjacent containers can be fixed together side by side or end to end using clamping devices, known as interconnectors, taken through the facing apertures of the adjacent corner fittings.

Such interconnectors, as e.g. known from U.S. Pat. No. 6,725,507, comprise a housing receiving an actuator shaft provided at both ends with a clamping head. Adjacent to each clamping head is a shear block. The actuator shaft is rotated by means of a radially extending actuator stem.

The object of the present disclosure is to provide an improved coupling system for containers.

### BRIEF SUMMARY

The present disclosure relates to a coupling device for a container.

According to the disclosure, the coupling device for a container, comprises:
a housing defining a chamber extending along a longitudinal axis, the housing having axially opposed front and rear ends, as well as a front opening at the front end;
a hollow shaft, referred to as coupling shaft, defining a cylindrical passage, reciprocally displaceable in the chamber along the axis, the shaft being selectively moveable between a rest position and an active position, wherein the shaft is moved axially forward (outward) to engage a cooperating mating receptacle (of an adjacent container);
one or more detent elements provided in the coupling shaft and displaceable therein between a retracted position and a retaining position, wherein the detent element(s) protrude through respective lateral opening(s) in the front portion of the coupling shaft, whereby the detent element(s) come into locking engagement with the mating receptacle;
a control pin reciprocally arranged inside the coupling shaft and comprising a front section configured for interacting with the detent elements, wherein the control pin is selectively moveable between a rest position, corresponding to the retracted position of the detent elements, and an active position, wherein the control pin is moved forward inside the coupling shaft in order to move the detent elements into their retaining position, whereby the front section of the pin is configured to support the detent elements in both positions.
actuating means configured to allow selectively controlling movement of the coupling shaft to move it from the rest position to the active position, and of the control pin, to move the detents elements from the retracted position to the retaining position.

The coupling device is generally part of a container and permits firmly interconnecting two adjacent containers by cooperation of the coupling device with a mating receptacle in the adjacent container. The coupling device is thus configured to be integrated/mounted in a container, in particular in a container frame structure and more specifically in a beam/girder of such frame structure.

The present disclosure proposes a different approach, since instead of simple passive corner castings, the containers are equipped with the coupling device and are thus ready for engagement with another container comprising a matching receptacle. There is no need for additional interconnecting devices.

In embodiments, the front section of the control pin has an axially tapering shape towards the front end, so that the portion of control pin that interacts with the detent elements in the active position has a larger cross-section than that of the portion interacting with the detent elements in the rest position of the control pin. Preferably, in the active position of the control pin, the detent elements sit on a flat section with the larger cross-section.

The tapering front section of the control pin may be formed as a truncated ogive-shaped head, with a radially protruding base diameter.

Advantageously, a spring assembly is arranged between the coupling shaft and control pin, so as to oppose a return force when the control pin is moved frontward relative to the coupling shaft. The stiffness of the spring assembly is such that the control pin only starts moving inside the coupling shaft when the latter has reached the active position.

The spring assembly may comprise a plurality of spring washers piled up in the axial direction around the control pin and resting at one end against a flange radially extending from the control pin and at the opposite end against shoulder in the passage inside the coupling shaft.

In embodiments, in the active position, the coupling shaft rests against an abutment surface in the housing and has its front section with the lateral openings protruding out of the housing.

In embodiments, an annular sleeve arranged in the housing to partially surround the coupling shaft, the internal diameter of the sleeve corresponding to the outer diameter of the coupling shaft to provide an axial guide, the coupling shaft having a base section with an outer diameter larger than the sleeve, which comes, in the active position, to rest against the sleeve.

In embodiments, a stop member is mounted at the rear end of the coupling shaft and protruding in the passage to form a rear stop for the control pin.

A cover plate may be fixed at the front extremity of the coupling shaft to close the passage.

The actuating means may generally comprise an actuating rod configured to move the coupling shaft and/or control pin in the axial direction between the rest and active positions.

This actuating rod can be moved by any appropriate means, e.g. based on electrical energy, hydraulic energy or manual energy.

In embodiments, the actuating rod is a spindle with a threaded surface coupled to a drive arrangement, the spindle partially extending axially inside an axial cavity in the control pin. A nut block is engaged on the spindle to move axially there along as the spindle is rotated, and in order to control the axial position of the control pin.

The nut block may have a tubular body and is rigidly fixed at its front end to the control pin, in particular by a front flange, the tubular body and front end being dimensioned to enter the passage in the coupling shaft. The nut block may comprise a rear end with a radial flange of larger cross-section, to come into abutment with the coupling shaft when the latter is in active position.

In embodiments, the drive arrangement includes a worm drive, whereby a worm gear is an endless screw in meshing engagement and connected to the spindle inside the housing, and a worm screw in meshing engagement with the endless screwworm gear, with the worm screw having a coupling end protruding out of the said housing for applying a drive torque thereto.

The coupling end of the endless screw may be coupled to one of an electric motor, a pneumatic drive and a hydraulic drive.

In embodiments, the drive force is provided by an electric motor which can be arranged laterally or axially with respect to the actuating rod.

The worm screw may have a second coupling end protruding out of the housing that is shaped for engagement with a manual crank.

In embodiments, the actuating means include a pressure cylinder with a plunger reciprocally moveable therein, said plunger being rigidly connected to the control pin.

In general, the housing is at least in part defined by a container beam, typically a hollow steel beam in which the coupling device is integrated.

The present disclosure can be integrated on various types/sizes of containers, to be carried on trucks or trailers of various dimensions, or on trains or ships. The coupling device allows containers to be modular, such that they are combined in various multiples to form a larger container. This larger container can be handled and carried as a singular unit. In return, the larger container can be divided into container modules that can be carried as individual units.

According to another aspect, the disclosure concerns a coupling system.

According to another aspect, the disclosure concerns a beam for a container frame structure, and a container.

### BRIEF DESCRIPTION OF THE DRAWINGS

Further details and advantages of the present disclosure will be apparent from the following detailed description of not limiting embodiments with reference to the attached drawings, wherein:

FIG. 1: is a perspective sectional view through an embodiment of the present coupling device, in rest position;

FIG. 2: is an exploded view of the coupling device of FIG. 1;

FIGS. 3 to 5: are cross-sectional views through the coupling device of FIG. 1, respectively in rest, intermediate and locking position;

FIG. 6: shows the receptacle in A) perspective view, B) cross-sectional view and C) front view

FIG. 7: is a principle view of a beam equipped with the coupling device of FIG. 1.

### DETAILED DESCRIPTION

An embodiment of the present coupling device 10 for container will be described with reference to the attached drawings. The purpose of the present coupling device 10 is to couple together two adjacent containers. The coupling device 10 is designed to be fixedly mounted to a first container and has a coupling member able to come into locking engagement with a mating receptacle in an adjacent, second container. As it will be understood, the coupling device 10 forms a male coupler, whereas the receptacle is the female coupler.

The coupling device 10 comprises a housing 12 extending along a longitudinal axis A. The housing 12 has a generally square cross-section and defines a longitudinal chamber 14. The housing 12 has a front end 16, proximal to the adjacent container to be coupled to, and an opposite rear end 18.

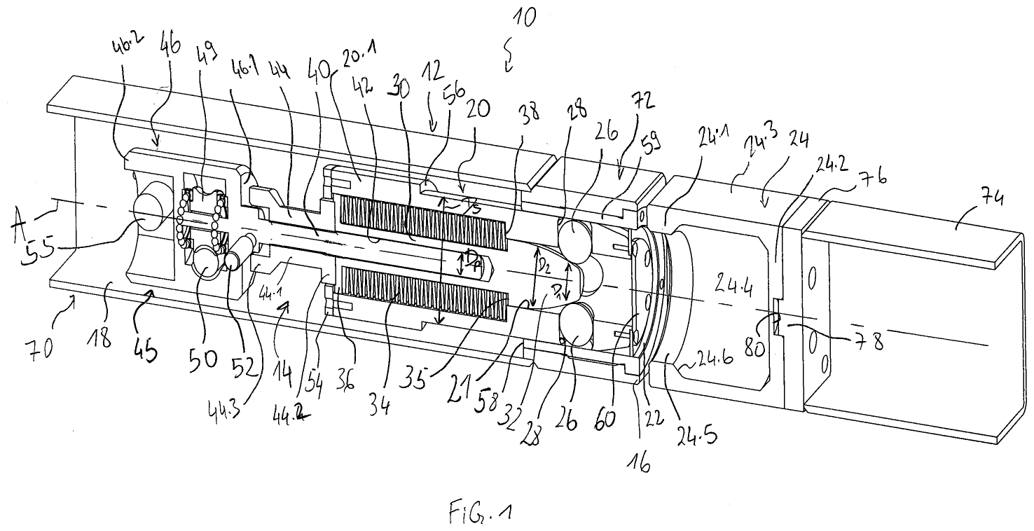

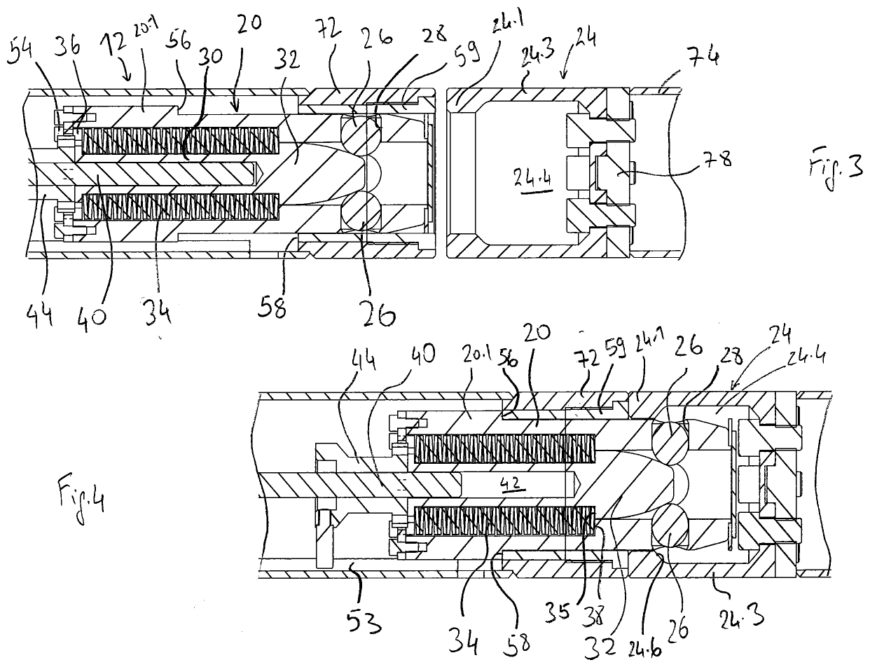

A hollow shaft 20, herein also referred to as coupling shaft, is reciprocally displaceable in the chamber 14 along axis A. The coupling shaft 20 extends along axis A and has a central through passage 21 extending along axis A. The outer diameter of the coupling shaft 20 is generally adapted to the inner cross-section of the housing 12 so that it can slide therein. In this embodiment, the coupling shaft 20 has a main section with an outer diameter Ds, the front end having a slight taper, and has an enlarged base 20.1 at the rear. The coupling shaft 20 is reciprocally moveable between a rest position (FIGS. 1 and 3) and an active position (FIGS. 4 and 5), wherein the coupling shaft 20 is moved axially forward, through a front opening 22 in housing 12, in order to engage a mating receptacle 24 in the adjacent, second container. In the following, the term “front” generally refers to a portion of the coupling device 10 situated towards the front end 16 of housing 12 (i.e. on the right in the drawings), whereas the term “rear” refers to opposite housing region towards the rear end 18 (on the left in the drawings).

Reference sign 26 designates balls arranged inside the coupling shaft 20 and displaceable therein between a retracted position (FIG. 3) and a retaining position (FIG. 5), wherein the balls 26 protrude through lateral openings 26 in the front portion of the coupling shaft 20. In this variant, four balls 26 are arranged in four lateral openings 28 that are circumferentially distributed. These balls 26 allow bringing the coupling device 10 in locking configuration when the coupling shaft 20 is engaged inside the mating receptacle 24, to realize coupling of the first and second containers, as will be discussed in detail below.

The coupling device 10 comprises actuating means configured to selectively control movement of the coupling shaft 20, to move it from the rest position to the active position, and of the balls 26, to move them from the retracted position to the retaining position.

Reference sign 30 designates an internal pin, or control pin, arranged inside the coupling shaft 20, i.e. in the passage 21, and reciprocally moveable therein. The control pin 30 has a front end configured for interacting with the balls 26. The control pin 30 is moveable between a rest position, corresponding to the retracted position of the detent elements (FIG. 3), and an active position, wherein the control pin 30 is moved forward inside the coupling shaft 20 in order to move the balls 26 in the retaining position (FIG. 5). The front end of the control pin 30 is configured to support the balls 26 in both positions.

In the present embodiment, the front end 32 of the control pin 30 is formed as an enlarged head, with a cross-section tapering toward the extremity. The head 32 has a kind of truncated ogive shape. The circumference is circular; the base of the head 32 has the largest diameter, which progressively decreases to the lowest diameter at the front end.

A spring assembly 34, formed by a plurality of spring washers plied up along the control pin 30, is arranged between the base of the head 32 (resting against a radial shoulder 35) and a radial flange 36 protruding from the rear of the control pin 30. Towards the front end, the spring assembly 34 also rests against a radial shoulder 38 in the passage 21. As it will be understood, this spring assembly 34 opposes a return force when the control pin 30 is moved forward inside the coupling shaft 20.

Actuating means are provided to selectively move the coupling shaft 20 relative to the housing 12 and the control pin 30 relative to the coupling shaft 20. In the present embodiment, the actuating means include a spindle 40 extending along axis A and forming an actuating rod. The spindle 40 is arranged towards the rear of the housing 12 and partially extends inside an inner axial cavity 42 in the control pin 30. The outer surface of spindle 40 is threaded on most of its length, in order to cooperate with a nut block 44 engaged thereon. The nut block has a tubular body 44.1 with a threaded inner passage as well as front and rear radial flanges 44.2, 44.3. As can be seen, the nut block 44 is arranged between the rear of the control pin 30 and a drive arrangement 45. In this embodiment, the drive arrangement 45 includes a casing 46 enclosing a worm drive. It has a front wall 46.1, a rear end 46.2, and lateral sides 46.3 forming a generally oblong cross-section. The spindle 40 enters the casing 46 via an opening in the front wall 46.1, 46.2. Inside the casing 46, the end of the spindle 40 is connected (integral in rotation) to a worm wheel 49, which is in meshing engagement with a worm screw 50. Rotation of the worm screw 50 will thus cause rotation of the worm wheel 49 and hence that of the spindle 40.

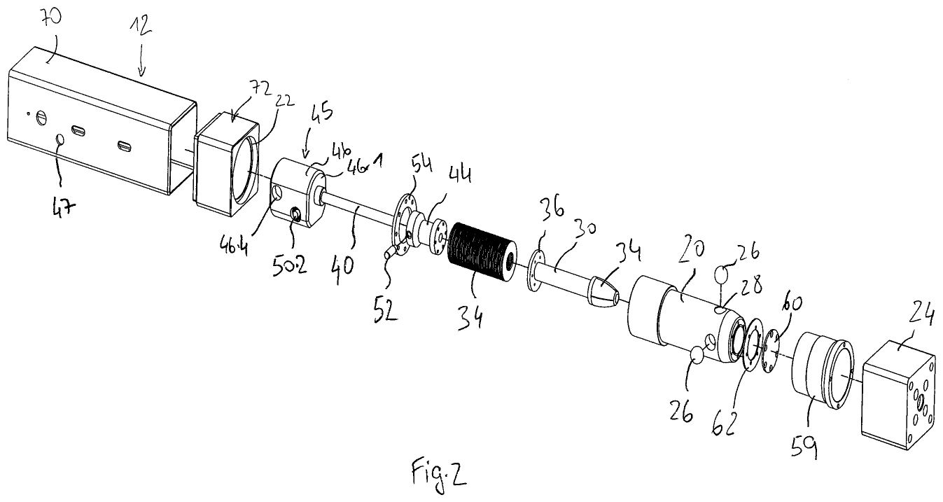

The worm screw 50 extends outside the casing 46 and outside the housing 12 through respective openings in opposite lateral walls (see FIG. 2, one opening 47 is shown). On one side, the outer section 50.1 of the worm screw 50 is coupled to drive means, such as e.g. an electric motor 51, a hydraulic drive, or any appropriate drive means. On the opposite side, outer section 50.2 of the worm screw 50 has a profiled end, e.g. hexagonal, to be coupled to a crank for manual actuation.

The drive arrangement is fixed in the housing 12 by means of a pin 55 extending though openings 46.4 in the casing 46 and housing 12 walls.

In this embodiment, the nut block 44 is blocked against rotation by a radially extending pin 52 that is screwed at one end in the nut block 44 and engages, at the opposite end, into an axial groove 53 (FIG. 4) in the housing 12, and can slide therein.

Optionally, the rear of the housing 12 may be closed by a rear wall.

As it will be understood, rotating the spindle 40 in one or the other direction, by means e.g. of an electric motor 51 (shown in FIG. 5) connected to the worm screw 50, will permit moving the nut block 44 forward or rearward, and thus control the position of the control pin 30 and the coupling shaft 20, respectively.

In alternative embodiments, the electric motor 51 may be arranged axially with respect to the coupling device, resp. with respect to spindle 40. That is, the motor may be arranged inside housing 12, resp. within beam 70, at the rear of the worm drive arrangement, the electrical motor thus having its output axis generally parallel to the axis of spindle 40.

Operation of the coupling device 10 will now be explained based on FIGS. 3 to 5. The starting position is the rest position shown in FIG. 3, also corresponding to FIG. 1. The coupling shaft 20 is inside the housing 12, in rest position, and the control pin 30 is likewise in rest position. The head 32 of the control pin 30 is retracted with respect to the front portion of the coupling shaft 20. The balls 26 are supported by the front most part of the head 32, with a diameter D1, which is such that the balls 26 are maintained in the lateral openings 28 without protruding outside of the coupling shaft's 20 lateral surface (or only slightly).

In the rest position the rear end of the control pin 30 is here aligned with that of the coupling shaft 20. Therefore, a flat ring 54 is affixed, e.g. by screws, to the bottom face of the coupling shaft 20. The flat ring 54 extends radially inwardly, into the passage 21, forming a radially extending, rear stop surface for the control pin 30. The nut block 44 lies against the rear end of the control pin 30. The nut block 44 is preferably fixed to the control pin 30, e.g. by screws uniting front flange 44.2 with flange 36.

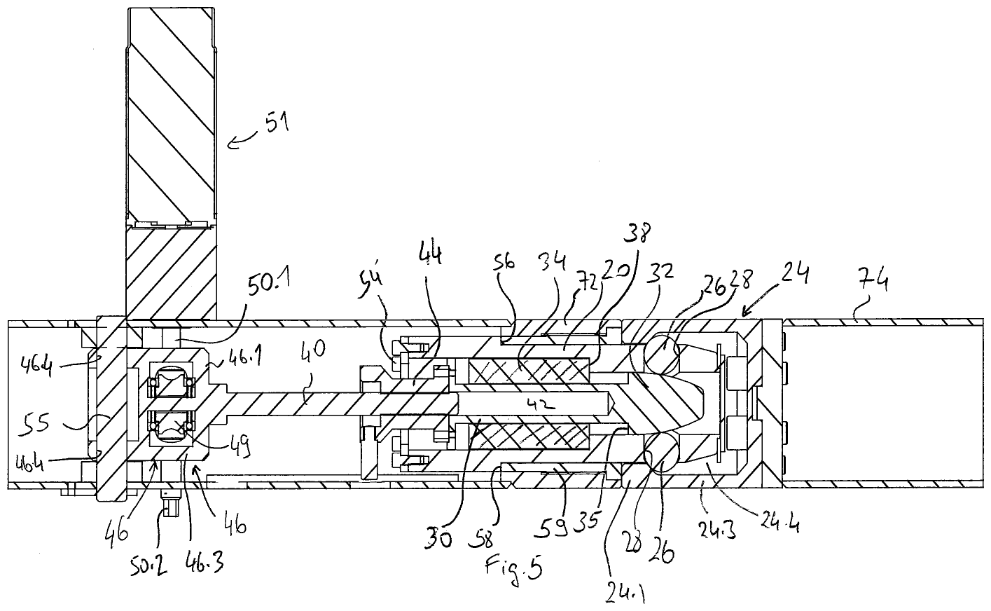

As indicated, the coupling device 10 is integrated to a container, and before actuation of the coupling device 10, the container to be joined is positioned such that its cooperating part is aligned with the front opening 22 of the coupling device 10. As best seen in FIG. 6A, the cooperating part is typically a parallelepiped-like element, designated 24, forming a receptacle for the coupling shaft 20. The mating receptacle 24 comprises six walls (front wall 24.1, rear wall 24.2 and lateral walls 24.3) defining an inner chamber/cavity 24.4 with an opening 24.5 in the front wall 24.1, the opening 24.5 having a diameter matching the outer diameter Ds of the coupling shaft 20, with some operational play.

Once the containers are positioned so that the front opening 22 of the coupling device 10 and the opening 24.5 of the matching mating receptacle 24 are aligned, the drive means are activated (e.g. energizing the electric motor) to rotate the spindle 40 in the direction allowing the nut block 44 to move forwardly (towards the right in the figures).

As the nut block 44 moves forwardly, both the control pin 30 and the coupling shaft 20 move together forward, whereby the front portion of the coupling shaft 20 progressively moves out of the housing 12 and enters the cavity 24.4 in the mating receptacle 24, via opening 24.5, to bring the coupling shaft 20 in the active position. This is the configuration shown in FIG. 4.

The outward stroke (longitudinal displacement) of the coupling shaft 20 is thus controlled by means of the actuating means, and preferably limited by a mechanical stop. Therefore, the enlarged base of the coupling shaft 20 forms, with respect to the main section with diameter Ds, a radial base shoulder 56. When the coupling shaft 20 is moved outwardly into its active position, this base shoulder 56 comes into abutment against a radial annular surface 58 in the housing. In this embodiment, the abutment surface 58 is the end face of an annular sleeve 59 arranged in the front portion of housing 12. Sleeve 59 acts a bearing-like member for guiding the coupling shaft 20. The internal diameter of sleeve 59 matches the coupling shaft diameter Ds, with some operational clearance.

From the intermediate configuration of FIG. 4, as the spindle 40 is further rotated, with the coupling shaft 20 in abutment against housing stop surface 58, the control pin 30 moves progressively forward, relative to the coupling shaft 20 (inside the passage 21), compressing the spring assembly 34. In doing so, the balls 26 come progressively into contact with a larger diameter section of the head 32, and thus progressively protrude out from the coupling shaft 20. The outward stroke of the control pin 30 ends when the spring assembly 34 is considerably compressed, coinciding with the balls 26 being forced outwardly by the large diameter section D2 at the base of the head 32.

This configuration is shown in FIG. 5; it is the locking configuration. The coupling shaft 20 is fully deployed as well as the balls 26. The balls 26 have their protruding portions engaged behind the front wall 24.1 with opening 24.5. The receptacle opening 24.5 has a diameter corresponding to the outer diameter Ds of the coupling shaft 20, so that with the balls 26 protruding out in retaining position, it is impossible to withdraw the coupling shaft 20 from mating receptacle 24. In the drawings, the inner side of the front wall 24.1 comprises an annular seat 24.6 for the balls 26. The annular seat 24.6 surrounds opening 24.5 and preferably has a frusto-conical surface. For improved locking, the coupling shaft 20 and its stroke length are designed such that, in active position, the balls 26 are radially aligned with the seat 24.6. Accordingly, when the balls 26 are moved out by the control pin 30, they are directly applied right behind the wall 24.1 onto the seat 24.6. Since the coupling shaft 20 is also in abutment in the housing 20 against surface 58, the coupling shaft 20 cannot move and the receptacle 24 is blocked against the coupling device 10.

Furthermore, the length of the portion of the coupling shaft 20 protruding into the receptacle chamber 24.4 is matched with the depth of chamber 24.5, so that in the active position of the coupling shaft 20, the latter is in abutment against the rear wall 24.2.

Reference sign 60 designates a cover plate fixed (e.g. screwed) at the front of the coupling shaft 20, closing channel 21. An annular rubber seal 62 is interposed.

In this configuration, the two containers are solidly attached to one another. To decouple the containers, it suffices to actuate the drive means (motor 51) in such a way as to rotate spindle 40 in the opposite direction. The control pin 30 will first move inwardly, i.e. to the left, allowing the balls 26 to retract, and then followed by the coupling shaft 20 moving inward.

Unless otherwise mentioned, the components of the coupling device are generally made of metal, preferably steel.

In embodiments, the coupling device 10 may include one or more position sensors to detect the position of the coupling shaft. Optical sensors may e.g. be used.

The housing 12 of the coupling device 10 can be an independent box-like element, for example made from steel, that is solidly fixed in the container, e.g. bolted, riveted or welded to a beam of the container frame.

Alternatively, as shown herein, the coupling device 10 can be integrated in a beam of the container frame, whereby the housing 12 is partly formed by the beam. The beam is a hollow section beam of square cross-section. The coupling device components are arranged inside the beam end indicated 70. A housing cover 72 is arranged in axial continuation of the beam end 70. The cover 72 is firmly fixed to the beam end 70, e.g. by welding or bolting. The outer shape of cover 72 is similar to beam end 70. The annular sleeve 59 is arranged in the housing cover 72.

The mating receptacle 24 is likewise solidly fixed to a beam 74 of the adjacent container. The mating receptacle 24 is mounted with its rear wall 24.2 against the end face of beam 74, e.g. against an end plate 76, e.g. by screwing. End plate 76 includes a centering protrusion 78 that engages a corresponding recess 80 in rear wall 24.2.

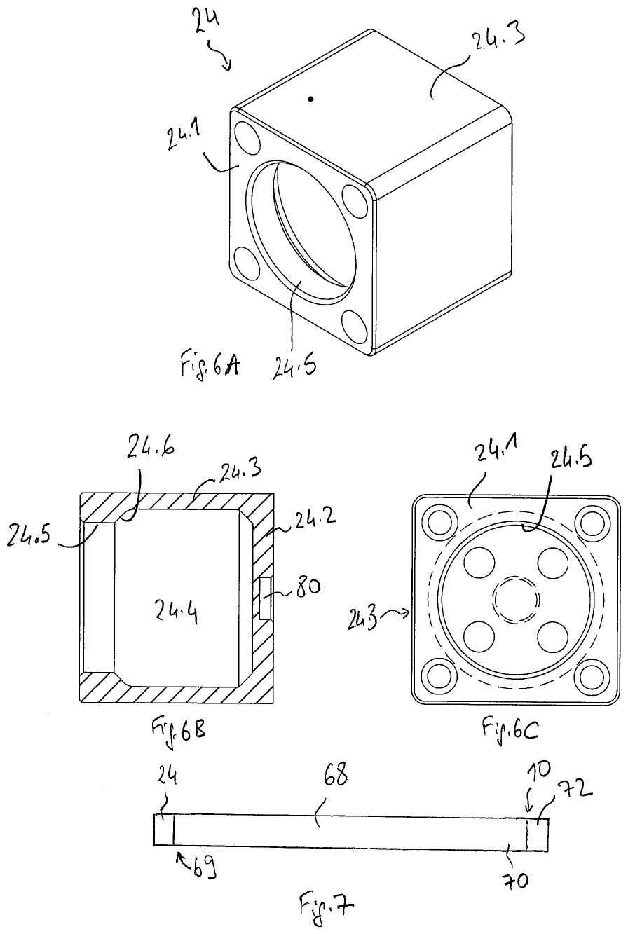

FIG. 7 is a sketch of a structural hollow beam 68 for a container frame. As explained above, one end 70 of the beam integrates the coupling device 10, serving as a housing for the latter. Alternatively, the coupling device can have its own housing and be mounted inside beam of fixed in axial continuation of beam 68, by screwing or welding. At the opposite end 69, the beam 68 includes a mating receptacle 24 (mechanically fixed thereto by screws, or could be welded). Alternatively the end of the beam 68 can be configured to form the receptacle. The length of beam 68 accounted for in the container frame is the total length, including the mating receptacle 24 and the housing cover 72. The length of the beam typically corresponds to the desired container length, since in operation the respective front opening 22 of the coupling devices and the openings 24.5 of the mating receptacles 24 should be substantially flush with the longitudinal ends of the container, for ease of assembly of two containers arranged end to end.

In the container assembly, two beams 68 may be used in the lower portion and two beams 68 in the upper portion, connected with an appropriate number of transverse and vertical beams, depending on the design.

1. A coupling device for a container comprising:
a housing defining a chamber extending along a longitudinal axis, the housing having axially opposed front and rear ends, as well as a front opening at the front end;
a hollow shaft having a cylindrical passage therein, reciprocally displaceable in the chamber along the axis, the shaft being selectively moveable between a rest position and an active position, wherein the shaft is moved axially forward to engage a cooperating mating receptacle;
one or more detent elements provided in the shaft and displaceable therein between a retracted position and a retaining position, wherein the detent element(s) protrude through respective lateral opening(s) in the front portion of the shaft, whereby the detent element(s) come into locking engagement with the mating receptacle;
a control pin reciprocally arranged inside the shaft and comprising a front section configured for interacting with the detent elements, wherein the control pin is selectively moveable between a rest position, corresponding to the retracted position of the detent elements, and an active position, wherein the control pin is moved forward inside the shaft in order to move the detent elements into their retaining position, whereby the front section of the control pin is configured to support the detent elements in both positions; and
actuating means configured to selectively control movement of the shaft to move it from the rest position to the active position, and of the control pin, to move the detents elements from the retracted position to the retaining position.

2. The coupling device according to claim 1, wherein the front section of the control pin has an axially tapering shape towards the front end, so that the portion of control pin that interacts with the detent elements in the retaining position has a larger cross-section than that of the portion interacting with the detent elements in the retracted position of the control pin.

3. The coupling device according to claim 2, wherein the tapering front section of the control pin forms a truncated ogive-shaped head, with a radially protruding base diameter.

4. The coupling device according to claim 1, comprising a spring assembly arranged between the shaft and control pin, so as to oppose a return force when the control pin is moved frontward relative to the shaft.

5. The coupling device according to claim 4, wherein the spring assembly comprises a plurality of spring washers piled up in the axial direction around the control pin and resting at one end against a flange radially extending from the control pin and at the opposite end against a shoulder in the passage inside the shaft.

6. The coupling device according to claim 1, wherein in the active position, the shaft rests against an abutment surface in the housing, and has its front portion with the lateral openings protruding out of the housing.

7. The coupling device according to claim 6, comprising an annular sleeve arranged in the housing to partially surround the shaft, the internal diameter of the sleeve corresponding to the outer diameter of the shaft to provide an axial guide, the shaft having a base section with an outer diameter larger than the sleeve inner diameter, which comes, in the active position, to rest against the sleeve.

8. The coupling device according to claim 1, comprising a stop member mounted at a rear end of the shaft and protruding in the passage to form a rear stop for the control pin.

9. The coupling system according to claim 1, comprising a cover plate fixed at the front extremity of the shaft to close the passage.

10. The coupling device according to claim 1, wherein the actuating means comprise an actuating rod configured to move the shaft and/or control pin in the axial direction between the rest and active positions.

11. The coupling device according to claim 1, wherein
the actuating rod is a spindle with a threaded surface coupled to a drive arrangement, the spindle partially extending axially inside an axial cavity in the control pin;
and a nut block is engaged on the spindle to move axially there along as the spindle is rotated, and in order to control the axial position of the control pin.

12. The coupling device according to claim 11, wherein
the nut block has a tubular body and is rigidly fixed at its front end to the control pin, in particular by a front flange, with the tubular body and front-end being dimensioned to enter the passage in the shaft, and
the nut block has a rear end with a radial flange of larger cross-section, to come into abutment with the shaft when the latter is in active position.

13. The coupling device according to claim 11, wherein: the drive arrangement includes a worm drive, whereby a worm wheel is connected with the spindle, and a worm screw is in meshing engagement with the worm wheel, and the worm screw having a coupling end protruding out of the housing for applying a drive torque thereto.

14. The coupling device according to claim 13, wherein the coupling end of the worm screw is coupled to an electric motor, or pneumatic or hydraulic drive.

15. The coupling system according to claim 13, wherein the worm screw has a second coupling end protruding out of the housing that is shaped for engagement with a manual crank.

16. The coupling device according to claim 1, wherein the actuating means include a pressure cylinder with a plunger reciprocally moveable therein, said plunger being rigidly connected to the control pin.

17. The coupling device according to claim 1, wherein the housing is at least in part defined by a container beam.

18. A coupling system comprising:
a coupling device as claimed in claim 1;
and a mating receptacle comprising a wall with an aperture therein opening into a chamber, the receptacle configured to accommodate therein the shaft in active position, the balls in the retaining position extending radially beyond the passage diameter of the aperture, in order to bring the coupling device in locking engagement with the mating receptacle.

19. A beam for a container frame structure comprising a coupling system according to claim 18, wherein the coupling device is mounted at one end of a beam and the mating receptacle is mounted at the other end of the beam.

20. The beam according to claim 19, wherein the coupling device has its housing formed in part by the hollow beam and the mating receptacle is fixed to the beam end by screwing or welding.

21. A beam for a container frame structure comprising at one end a coupling device as claimed in claim 1 and at the opposite a receptacle portion integrated in the beam end.

22. A container comprising a beam structure and panels fixed to the beam structure to define the storage volume, wherein the beam structure includes at least one beam as claimed in claim 19.

23. The container according to claim 22, wherein said at least one beam with the coupling device and receptacle is a longitudinal beam covering essentially the whole length of the container.
